(19) United States
(12) Patent Application Publication
(10) Pub. No.: US 2006/0095295 A1
(43) Pub. Date: May 4, 2006

(54) Method and system of pre-registration for vaccines

(76) Inventor: Prem Ramaswami, Neshanic Station, NJ (US)

Correspondence Address: Global IP Services PLLC;c/o PortfolioIP, P.O. Box 52050, Minneapolis, MN, 55402, US

(21) Appl. No.: 10/978,664

(22) Filed: Nov. 1, 2004

(51) Int. Cl. G06Q 10/00; G06Q 50/00

(52) U.S. Cl. 705/2

(57) ABSTRACT

A pre-registration scheme for vaccines allows near certain delivery to an end user. In one example embodiment, this is accomplished by receiving user information including a name and identifiable information. A user information validation screen, including a field requesting a name and identifiable information, is then displayed. The user information, including the name and the identifiable information, is then entered into the validation screen. The user information is then validated. Vaccination information including a vaccination type and a desired date and time is received from the user. A vaccination screen including a field for vaccination type, date and time is then displayed. The desired vaccination type, date and time is then entered and stored in the database. A confirmation number is then displayed and outputted.

### FIELD OF THE INVENTION

This invention relates to the field of vaccines, and more particularly to a system for pre-registration for vaccines.

### BACKGROUND OF THE INVENTION

Approximately, 36,000 people die every year due to flu outbreaks. Much of the outbreaks of the flu are preventable given that effective flu vaccines do exist. While there are many causes for not being able to vaccinate all or most susceptible, a prominent cause is the inability to match supply and demand for the vaccine. No formal, centralized system exists for the susceptible to register and pre-order vaccines and be assured of receiving a vaccine. Distributors tend to play it safe and order the barely adequate quantities to prevent loss from unused supplies. Manufacturers in turn are unable to respond quickly to observed swings in demand due to required lead times in the manufacturing process.

Fall of 2003 brought forth an unusually strong flu season. Due to the virulence of the year's flu and high sickness rate associated with it, many scrambled to get flu shots. Unfortunately, the distributors of the flu vaccine underestimated the consumer demand, only ordering manufacturers to produce about 87.1 million doses of the influenza vaccine. Large lines ensued and many people were left without the flu vaccine.

Currently, organizations such as the University of Pittsburgh Medical Center (UPMC) and Visiting Nurses Foundation (VNF), which order flu vaccines, have difficulty gauging the required demand from consumers. For example, in 2002, the VNF were forced to donate a large portion of their purchased flu shots to Venezuela due to low turnout. In the following year, too few vaccines were ordered and many people were unable to receive a flu vaccine.

There are major groups of individuals who require a flu vaccine. Below are a few of those groups:

People age 50 and Older

Children between 6 months and 23 months of age

Young people, ages 6 months to 18 years, who are on long term aspirin therapy

Residents of nursing homes and other long term health care facilities

People with chronic heart or lung conditions, including asthma

Women who might be more than three months pregnant

Currently, only a few companies manufacture flu vaccines. Aventis Pasteur sells Fluzone and Chiron Corp. sells Fluvurin.

The VNF and other such organizations make the majority of their revenues from the flu vaccine programs. Generally for every dollar spent by them on flu vaccines, nearly $5.00 is earned by these organizations. At the same time, these organizations lose nearly $5.00 per flu vaccine that is acquired but not used. Therefore, the profitability of these organizations very much depends on properly matching supply and demand.

Generally, current schemes do not guarantee a flu vaccine even if an individual is in one of the high-risk categories. This is especially true for vaccines which require a manufacturing lead time and either have a short shelf life or may only be valid for the current year. There is no centralized method for distribution. Smaller organizations, such as doctor's offices, might make appointments weeks in advance even though they are forced to place orders for the flu vaccines six months in advance.

### BRIEF DESCRIPTION OF THE DRAWINGS

FIG. 1 is a flow chart illustrating a method of pre-registration for vaccines according to an embodiment of the present invention and the gained data.

FIG. 2 is a schematic block diagram of an information-processing system that can be used to run some or all portions of the invention.

### DESCRIPTION OF PREFERRED EMBODIMENTS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. The same reference number or label may refer to signals and connections, and the actual meaning will be clear from its use in the context of the description.

Terminology

The term “pre-registration” means registering a user for vaccination before placing the order for the vaccines.

A pre-registration program allows near certain delivery to the end user. The pre-registration scheme can also be designed to allow an end user to choose the interval of time, location, and so on to get the desired vaccine. This helps to prevent long lines and allows for the efficient delivery of the vaccine. In addition, the vaccine can possibly be purchased for a cheaper price.

Distributors have the ability to closely forecast one segment of the market demand. In addition, distributors will have minimum wastage and minimum loss from over or under supply. Pre-registration will allow for better customer service and timely availability of the product.

Through differentiated prices for those who pre-register and those who “walk-in” the service provider can obtain a cushion from potential losses due to unused or wasted vaccines.

The final goal of the pre-registration program is to have all individuals who wish to get a vaccine to pre-register.

Vaccine demand data for this segment is collected using the pre-registration process. The pre-registration process can include aggressive pre-registration programs to get as many individuals as possible to sign-up in advance for the vaccine. The pre-registration can include a customizable website (customizable per each company or organization looking for the process services). This website can take in the person's name, address information, insurance information, and the like. In addition, it can require the individual to enter information for some form of down payment for the vaccination. This payment may include credit card, debit card, direct check, cash, and the like.

In addition, different stations can be setup at areas where people congregate. This can include old age homes, school meetings, etc. This information will be collected by representatives with laptops using a compatible piece of software or can be recorded on paper and then later entered into this same system. Also, telephone, postal mail, and other media might be used for the registration process.

This whole process can be tied into one large database driven web application. This application will allow for fast and easy management of individuals in different regions. This web database can take care of certifying all information online. In addition, this procedure can be used to choose a time and location to receive the vaccine to make the delivery of the vaccine more efficient.

In addition, large mailing lists can be built from the people who demanded a vaccine in previous years. Since people who get a vaccine one year may be inclined to get it the following year, options for automatic payment (credit card based) can be setup through the pre-registration function.

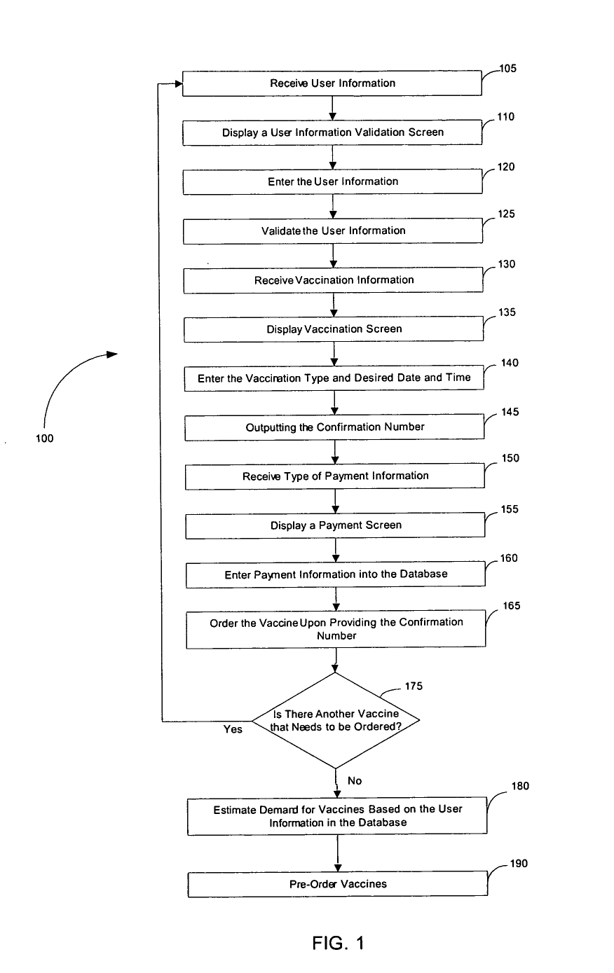

FIG. 1 illustrates an example method 100 of pre-registration for vaccines. At 105, this example method 100 receives user information including a user name and identifiable information. At 110, a user information validation screen is displayed. The displayed user information validation screen includes a field requesting a user name and identifiable information. The identifiable information can include information, such as user's address, user's company identification number, social security number, and so on. Further, the identifiable information can include information, such as age, sex, and the like.

At 120, the received user information is entered into the validation screen. In these embodiments, the received user name and identifiable information is entered into the fields requesting the user name and identifiable information. At 125, the entered user information is validated. If the entered user information is not in the database, then the received user information, including the user name and the identifiable information, is stored in the database. If the entered user information is in the database, then the entered user information is validated. The identifiable information can be information such as address, user's company identification number, social security number, and the like.

At 130, vaccination information is received from the user. The vaccination information received from the user includes vaccination type and desired date and time. At 135, a vaccination screen is displayed. The displayed vaccination screen includes a field for vaccination type and date and time. At 140, the received vaccination type and the desired date and time from the user are entered into the associated fields in the displayed vaccination screen.

At 145, a confirmation number is outputted. The confirmation number can be outputted by using output forms, such as sending an email message to the user, printing a hard copy for the user, sending a wireless message to the user, calling the user via a telephone, displaying the confirmation number on display device, sending the confirmation number via postal service and so on.

At 150, type of payment information is received from the user. The type of payment information received from the user can include cash, check, credit card, insurance, annual payment, and so on. At 155, a payment screen is displayed. The payment screen includes a field for type of payment. At 160, the received payment information is then entered into the payment screen and the database is updated based on the entered payment information. The received payment information is then validated and a receipt is provided to the user based on the entered payment information into the database.

In these embodiments, if the received payment is cash, then a cash payment screen is displayed. The cash payment screen includes a field for cash. The received cash information is entered into the filed for cash and a receipt for receiving the cash is provided to the user.

If the received payment is check, then a check payment screen is displayed. The check payment screen includes fields for check number, bank name, bank address, routing number, and/or ABA number. The check number, the bank name, the bank address, the routing number, and/or the ABA number are entered into the associated fields in the check payment screen based on the received check from the user and the check is validated. A receipt is provided to the user based on the outcome of the validation.

If the received payment type is via credit card, then displaying a credit card payment screen, which includes fields for credit card type, name on the credit card, credit card expiry date, and/or credit card number. The credit card type, the name on the credit card, the credit card expiry date and/or the credit card number are then entered into the associated fields and the database is updated. The credit card is then validated upon entering the associated fields in the credit card payment screen based on the credit card received from the user. A receipt is then provided to the user based on the outcome of the validation of the credit card received from the user.

If the received payment type is via patient medical insurance, then an insurance payment screen is displayed, which includes fields for insurance company name, primary insurers name, user name, and/or insurance number. The received insurance company name, the primary insurers name, the user name, and/or the insurance number are then entered into the associated fields in the insurance payment screen. The patient medical insurance is then validated based on the entered medical insurance information. A receipt is provided to the user based on the outcome of the validation of the medical insurance.

If the received payment type is via yearly billing, then a yearly billing screen in displayed, which includes fields for yearly billing information. The received yearly billing information is then entered into the fields in the yearly billing information and the yearly billing is validated. A receipt is then provided to the user based on the outcome of the validation of the entered yearly billing information.

At 165, the vaccine is ordered upon providing the confirmation number. The ordered vaccine can include vaccines such as a flu vaccine, a common cold vaccine, an AIDS vaccine, and other such vaccines that have short-shelf life, manufacturing lead time, and/or can change in formulation on a yearly basis. The final step can also include a certification step that confirms that the user has read the terms and condition of providing the above-described pre-registration scheme. This final step can also include another certification that the information provided by the user is correct.

At 175, the method 100 determines if there is another vaccine that needs to be ordered for another user. Based on the determination at 175, if there is another vaccine that needs to be ordered, then the method 100 goes to step 105 and repeats steps 105-165. Based on the determination at 175, if there are is no other vaccine that needs to be ordered for another user, then the method 100 goes to step 180.

At 180, demand for vaccines is estimated based on the updated user information in the database. At 190, the vaccines are pre-ordered based on the estimated demand.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

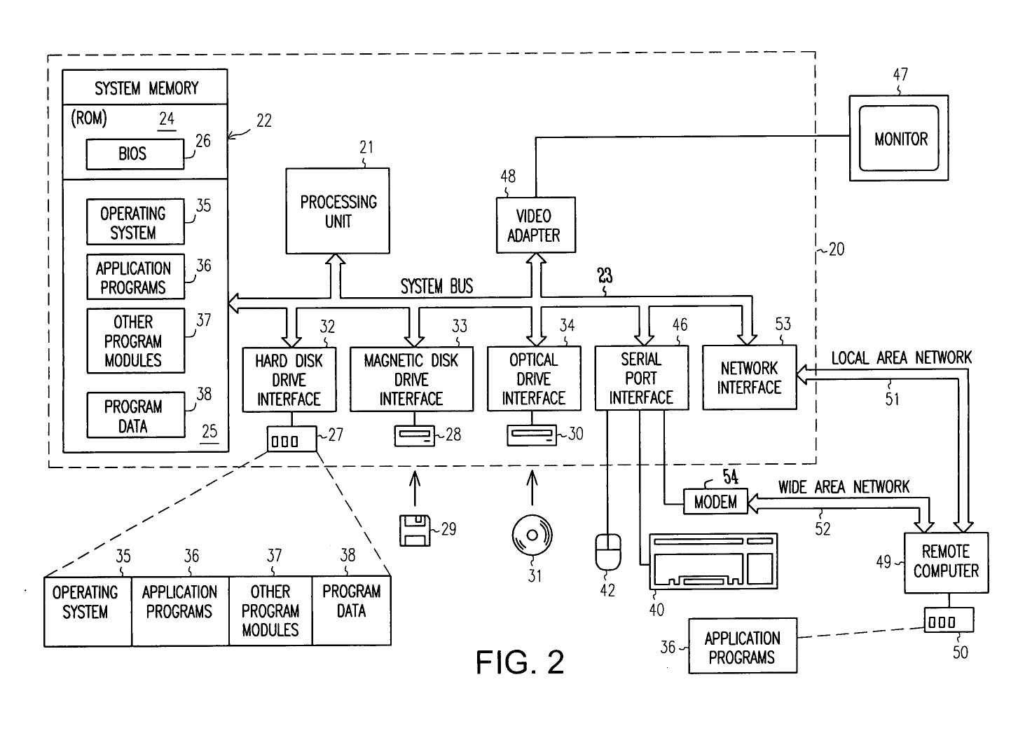

In the embodiment shown in FIG. 2, a hardware and operating environment is provided that is used to run some or all portions of the present invention.

As shown in FIG. 2, the hardware and operating environment includes a general purpose computing device in the form of a personal computer 20, or a server 20, including a processing unit 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 can be any of several types of bus structures including a memory bus or memory controller, a peripheral bus, and a local bus using any of a variety of bus architectures. The system memory can also be referred to as simply the memory, and includes read only memory (ROM) 24 and random access memory (RAM) 25. A basic input/output system (BIOS) 26, containing the basic routines that help to transfer information between elements within the computer 20, or a server 20, such as during start-up, may be stored in ROM 24. The computer 20, or a server 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non-volatile storage of computer-readable instructions, data structures, program modules and other data for the computer 20, or a server 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a vaccine pre-registration technique of the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20, or server 20; the invention is not limited to a particular type of communications device. The remote computer 49 can be another computer, a server, a router, a network PC, a client, a peer device or other common network node, and typically includes many or all of the elements described above I/O relative to the computer 20, or server 20, although only a memory storage device 50 has been illustrated in FIG. 2. The logical connections depicted in FIG. 2 include a local area network (LAN) 51 and a wide area network (WAN) 52. Such networking environments are commonplace in office networks, enterprise-wide computer networks, intranets and the Internet, which are all types of networks.

When used in a LAN-networking environment, the computer 20, or server 20, is connected to the LAN 51 through a network interface or adapter 53, which is one type of communications device. When used in a WAN-networking environment, the computer 20, or server 20, typically includes a modem 54, a type of communications device, or any other type of communications device, e.g., a wireless transceiver, for establishing communications over the wide area network 52, such as the Internet; the invention is not so limited. The modem 54, which may be internal or external, is connected to the system bus 23 via the serial port interface 46. In a networked environment, program modules depicted relative to the personal computer 20, or portions thereof, can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, WAP (wireless application protocol), and all other electronic media through any suitable switches, routers, outlets and power lines, as the same are known and understood by one of ordinary skill in the art.

The hardware and operating environment in conjunction with which embodiments-of the invention may be practiced has been described. The computer 20, or server 20, in conjunction with which embodiments of the invention can be practiced can be a conventional computer, a distributed computer, or any other type of computer; the invention is not so limited. Such a computer 20, or server 20, typically includes one or more processing units as its processor, and a computer-readable medium such as a memory. Computer 20 can also include a communications device such as a network adapter or a modem, so that it is able to communicatively couple to other computers, servers, or devices.

The need for above-described pre-registration technique is described in context of flu vaccines. It can be envisioned that the above technique can be deployed for vaccines (other than flu vaccines that have short shelf life) that are used to treat deceases, such as common cold, AIDS, and so on.

In the foregoing detailed description of embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the spirit and scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. A method of pre-registration for a vaccine, comprising:
receiving user information including a name and identifiable information;
displaying a user information validation screen, including a field requesting a name and identifiable information;
entering the user information, including the name and identifiable information, into the validation screen;
if the user information is not in the database, then storing the user information, including the name and identifiable information in a database;
if the user information is in the database, then validating the user information;
receiving vaccination information including vaccination type and desired date and time from the user;
displaying a vaccination screen including a field for vaccination type, date and time;
entering the vaccination type and the desired date and time and storing the vaccination information including the vaccination type and the desired date and time in the database; and
outputting a confirmation number.

2. The method of claim 1, further comprising:
receiving type of payment information, including cash, check, credit card, insurance, annual payment;
displaying a payment screen including a field for type of payment;
if the received payment type is cash, then displaying a cash payment screen including a filed for cash and entering the received cash information and providing a receipt to the user;
if the received payment type is a check, then displaying a check payment screen including fields for check number, bank name, bank address, routing number, and ABA number, entering the check number, bank name, bank address, the routing number, and the ABA number into the database and validating the check and providing a receipt to the user based on the outcome of the validation;
if the received payment is via a credit card, then displaying a credit card payment screen including fields for credit card type, name on the credit card, credit card expiry date, and credit card number, entering the credit card type, name on the credit card, credit card expiry date, and credit card number into the database, and validating the credit card and providing a receipt to the user based on the outcome of the validation;
if the received payment is via patient medical insurance, then displaying an insurance payment screen including fields for insurance company name, primary insurers name, user name, and insurance number, and entering the insurance company name, primary insurers name, user name, and insurance number and validating the patient medical insurance and providing a receipt to the user based on the outcome of the validation; and
if the received payment is via yearly billing, then displaying a yearly billing screen including fields for yearly billing information, and entering the yearly billing information into the fields on the yearly billing information screen and validating the patient yearly billing information and providing a receipt to the user based on the outcome of the validation.

3. The method of claim 1, wherein outputting the confirmation number comprises output forms selected from the group comprising sending an email message to the user, printing a hard copy for the user, sending a wireless message to the user, calling the user via a telephone, displaying the confirmation number on a display device, and sending the confirmation number via postal service.

4. The method of claim 1, further comprising:
ordering the vaccine upon providing the confirmation number.

5. The method of claim 1, wherein the vaccine comprises a vaccine selected from the comprising flu vaccine, common cold vaccine, and AIDS vaccine.

6. The method of claim 1, further comprising:
estimating demand for vaccines based on the updated user information in the database; and
pre-ordering vaccines based on the estimated demand.

7. An article comprising:
a storage medium having instructions that, when decoded by a computing platform, result in execution of a method comprising:
receiving user information including a name and identifiable information;
displaying a user information validation screen, including a field requesting a name and identifiable information;
entering the user information, including the name and identifiable information, into the validation screen;
if the user information is not in the database, then storing the user information, including the name and identifiable information in a database;
if the user information is in the database, then validating the user information;
receiving vaccination information including vaccination type and desired date and time from the user;
displaying a vaccination screen including a field for vaccination type, date and time;
entering the vaccination type and the desired date and time and storing the vaccination information including the vaccination type and the desired date and time in the database; and
outputting a confirmation number.

8. The article of claim 7, further comprising:
receiving type of payment information, including cash, check, credit card, insurance, annual payment;
displaying a payment screen including a field for type of payment;
if the received payment type is cash, then displaying a cash payment screen including a filed for cash and entering the received cash information and providing a receipt to the user;
if the received payment type is a check, then displaying a check payment screen including fields for check number, bank name, bank address, routing number, and ABA number, entering the check number, bank name, bank address, the routing number, and the ABA number into the database and validating the check and providing a receipt to the user based on the outcome of the validation;
if the received payment is via a credit card, then displaying a credit card payment screen including fields for credit card type, name on the credit card, credit card expiry date, and credit card number, entering the credit card type, name on the credit card, credit card expiry date, and credit card number into the database, and validating the credit card and providing a receipt to the user based on the outcome of the validation;
if the received payment is via patient medical insurance, then displaying an insurance payment screen including fields for insurance company name, primary insurers name, user name, and insurance number, and entering the insurance company name, primary insurers name, user name, and insurance number and validating the patient medical insurance and providing a receipt to the user based on the outcome of the validation; and
if the received payment is via yearly billing, then displaying a yearly billing screen including fields for yearly billing information, and entering the yearly billing information into the fields on the yearly billing information screen and validating the patient yearly billing information and providing a receipt to the user based on the outcome of the validation.

9. The article of claim 8, wherein outputting the confirmation number comprises output forms selected from the group comprising sending an email message to the user, printing a hard copy for the user, sending a wireless message to the user, calling the user via a telephone, displaying the confirmation number on a display device, and sending the confirmation number via postal service.

10. The article of claim 8, further comprising:
ordering the vaccine upon providing the confirmation number.

11. The article of claim 7, wherein the vaccine comprises a vaccine selected from the comprising flu vaccine, common cold vaccine, and AIDS vaccine.

12. The article of claim 7, further comprising:
estimating demand for vaccines based on the updated user information in the database; and
pre-ordering vaccines based on the estimated demand.

13. A computer system comprising:
a processor; and
a memory coupled to the processor, the memory having stored therein code which when decoded by the processor, the code causes the processor to perform a method comprising:
receiving user information including a name and identifiable information;
displaying a user information validation screen, including a field requesting a name and identifiable information;
entering the user information, including the name and identifiable information, into the validation screen;
if the user information is not in the database, then storing the user information, including the name and identifiable information in a database;
if the user information is in the database, then validating the user information;
receiving vaccination information including vaccination type and desired date and time from the user;
displaying a vaccination screen including a field for vaccination type, date and time;
entering the desired vaccination type and date and time and storing the vaccination information including the vaccination type and date and time in the database; and
outputting a confirmation number.

14. The system of claim 13, further comprising:
receiving type of payment information, including cash, check, credit card, insurance, annual payment;
displaying a payment screen including a field for type of payment;
if the received payment is cash, then displaying a cash payment screen including a filed for cash and entering the received cash and providing a receipt to the user;
if the received payment type is a check, then displaying a check payment screen including fields for check number, bank name, bank address, routing number, and ABA number, entering the check number, bank name, bank address, the routing number, and the ABA number into the database and validating the check and providing a receipt to the user based on the outcome of the validation;
if the received payment type is via a credit card, then displaying a credit card payment screen including fields for credit card type, name on the credit card, credit card expiry date, and credit card number, entering the credit card type, name on the credit card, credit card expiry date, and credit card number into the database, and validating the credit card and providing a receipt to the user based on the outcome of the validation;
if the received payment is via patient medical insurance, then displaying an insurance payment screen including fields for insurance company name, primary insurers name, user name, and insurance number, and entering the insurance company name, primary insurers name, user name, and insurance number and validating the patient medical insurance and providing a receipt to the user based on the outcome of the validation; and
if the received payment is via yearly billing, then displaying a yearly billing screen including fields for yearly billing information, and entering the yearly billing information into the fields on the yearly billing information screen and validating the patient yearly billing information and providing a receipt to the user based on the outcome of the validation.

15. The system of claim 13, wherein outputting the confirmation number comprises output forms selected from the group comprising sending an email message to the user, printing a hard copy for the user, sending a wireless message to the user, calling the user by a telephone, displaying the confirmation number on a display device, and sending the confirmation number via postal service.

16. The system of claim 13, further comprising:
ordering the vaccine upon providing the confirmation number.

17. The system of claim 13, wherein the vaccine comprises a vaccine selected from the comprising flu vaccine, common cold vaccine, and AIDS vaccine.

18. The system of claim 13, further comprising:
estimating demand for vaccines based on the updated user information in the database; and
pre-ordering vaccines based on the estimated demand.
